(19) United States
(12) Patent Application Publication
(10) Pub. No.: US 2003/0021103 A1
(43) Pub. Date: Jan. 30, 2003

(54) Light housing with insulated reflector

(76) Inventor: Cary Christie, Glen Brook, NV (US)

Correspondence Address: Levisohn, Lerner, Berger & Langsam, Suite 2400, 757 Third Avenue, New York, NY, 10017, US

(21) Appl. No.: 09/915,602

(22) Filed: Jul. 26, 2001

(51) Int. Cl. F21V 29/00; H04M 1/22

(52) U.S. Cl. 362/86; 362/294; 362/373

(57) ABSTRACT

A light source and its housing is provided with an insulating ceramic paint applied to the light reflector to isolate the heat from the light bulb and prevent it from irradiating upwardly into the light fixture thereby enhancing the efficiency of a light fixture by allowing larger wattage bulbs to be used.

### BACKGROUND OF INVENTION

This invention relates to a heat resistant light enclosure, and more particularly, to a light enclosure housing with an insulated reflector which further may include a wireless FM receiver integrated within the housing.

Spotlights are carried in housings generally mounted in ceilings or the like, and spotlights give off large amounts of heat. Spotlights include reflective surfaces or reflectors to focus the light and minimize the heat generated. But heat still irradiates around the housing which reduces the efficiency of the light source.

Applicant has also combined wireless FM systems used in conjunction with such spotlights so as to cause sound to be selectively generated from within the spotlight housing. Applicant's U.S. Pat. No. 5,980,057 is directed to this invention. Such spotlight housings are often installed in large commercial or retail establishments, and providing sound throughout the establishment or selectively within the establishment as often a desired objective.

In order to effectively operate such wireless systems, it is important to minimize the heat generated by the light from reaching the electronic components of the FM receiver in order to insure that the receiver components operate most efficiently.

An object of this invention is to provide a housing for a spotlight or the like in which heat irradiating from the region is materially confined and does not interfere with the efficient operation of light or any associated ancillary componentry.

Another object of this invention is to provide a combined sound-light system mountable in conventional ceilings sockets in which a heat insulator is provided between the source of light and the electronic components.

Still another object of this invention is to provide such a heat insulator for housing fixtures in which the heat insulation may be easily applied as by painting either individually at individual light fixtures or in the process of manufacturing without materially altering the cost of such light fixtures.

Other object, advantages or features of this invention will become more apparent from the following description.

### SUMMARY OF THE INVENTION

In accordance with the teachings of this invention, an insulating paint is specifically applied to the reflector portion of the enclosure surrounding the lightbulb to prevent the heat from irradiating behind the reflector. By preventing heat from the light from radiating upwardly toward the ceiling, it has been found that greater wattage can be employed utilizing the same power because of the reduction of the propagation of heat throughout the light housing fixture.

As another aspect of this invention, it has been found that a combined speaker-light assembly may be provided which is mountable in conventional ceiling sockets, and that standard chips can be employed and effectively operate without degradation which would occur if standard housings for the light bulbs were employed which permitted heat to propagate throughout the region above the light. Integrated circuits and electronic chips are generally heat sensitive, and it is important that such chips and circuitry be maintained within the appropriate range to operate effectively and efficiently.

The preferred insulating paint is a ceramic paint and an example of such is that identified as which creates a thermal barrier. The ceramic particles in Insuladd refract, reflect and dissipate heat. This ceramic paint employs ceramic sphere compounds as the primary insulating mechanism. While Insuladd and other similar paints are well known to create a thermal barrier, to the inventors knowledge, the combination of such insulating paints in conjunction with light fixtures to improve the efficiency of a light fixture has never been employed before.

Additionally, when the combined speaker light combination is employed, the insulating paint may be sprayed over the surface of the speaker driver to further isolate the speaker from the source of heat.

### BRIEF DESCRIPTION OF THE DRAWINGS

FIG. 1 is a sectional view through the housing a light fixture showing the housing for the bulb as well as the entire bulb itself which is not shown in this section.

FIG. 2 is a sectional view of a combined speaker-light assembly detailed description.

### DETAILED DESCRIPTION

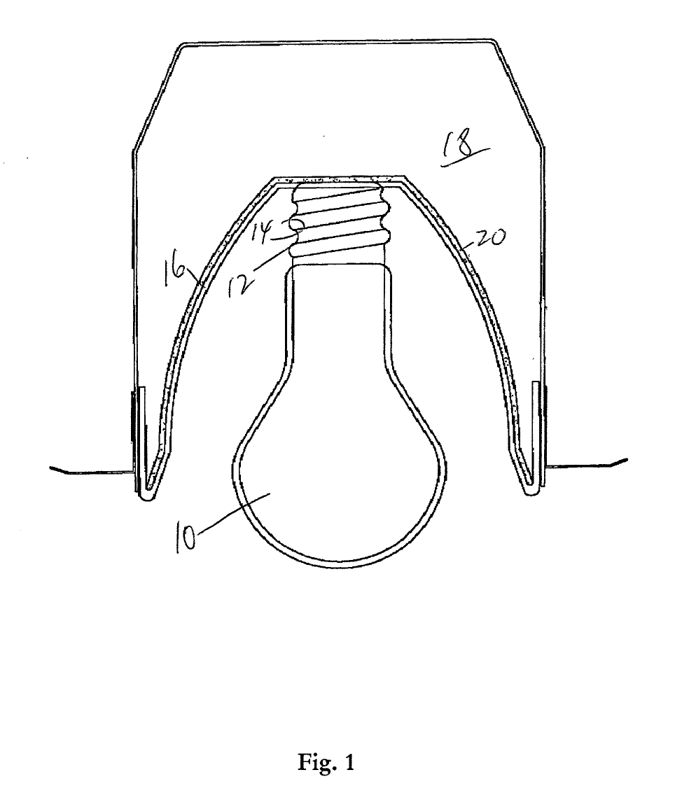

FIG. 1 illustrates a conventional lightbulb 10 having a threaded base 12 adapted to be inserted in a socket 14 which itself is attached to a reflective surface 16 formed as the lower part of a generalized housing 18 which houses the socket 14 to receive the threaded base 12. The housing may be of the type which is connected into a conventional ceiling fixture or other assembly so that the housing is generally indicated to include a reflective surface to enhance the amount of illumination.

In accordance with this invention, and insulating paint 20 is applied as by painting on the reflecting surface 16 to insulate and prevent heat from rising upwardly into the housing 18. The insulating paint is of the type generally described as containing a ceramic filler such as ceramic sphere compounds as the primary insulating mechanisms, and one type is known by the trademark Insuladd. By using the insulating paint in preventing heat from rising in the housing, it has been found that a higher power lightbulb 10 can be employed in the same housing thus rendering the overall light efficiency of the bulb and housing greater than previously obtainable.

The thickness of the insulating paint coating is chosen so as to provide effective insulation between the housing and the heat source, which is the bulb 10.

Another aspect of this invention is the provision of a conventional FM wireless receiver system which employs a speaker 22 having a driver 24 located above the housing 18 which carries a lightbulb 26 set within a socket 28. The lightbulb 26 is set in housing 18 which has a reflective surface 30 but which also employs an insulating paint layer 32 painted on the surface of 30.

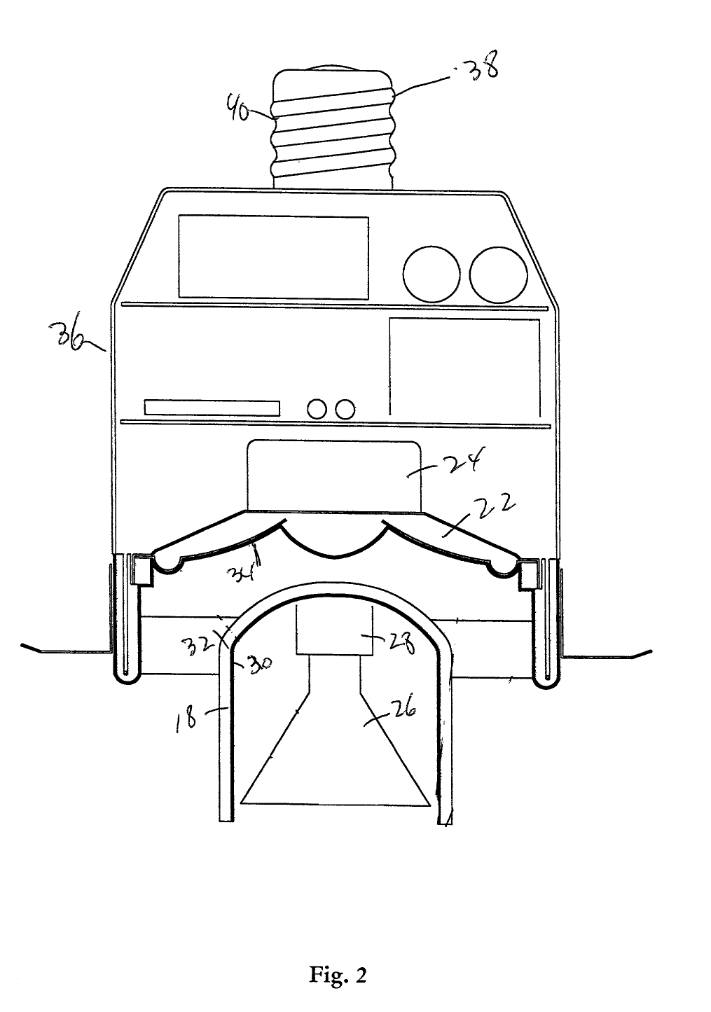

Speaker 22, with its driver 24, preferably includes a layer of insulating paint 34 painted on that portion of the speaker directly opposite the source of heat i.e., the housing 18 which holds lightbulb 26. The speaker-light assembly is itself included held in a housing 36 which is adapted to screw into a standard threaded socket (not shown) by means of threads 38 located on the top portion 40 of the housing 36. The specific arrangement of connecting the speaker light assembly to receive electrical power from a standard socket is preferably as that shown in FIG. 2, but other ways of providing electricity carried within the ceiling for generally electrifying light bulbs can also be employed to carry the electricity to power the speaker light assembly of FIG. 2. Speaker 22 generally receives an audio signal of sufficient amplitude to drive the speaker, and such signal can be generated by a standard wireless FM receiver or a wireless magnetic receiver housed within housing 36. Such a system is described in my U.S. Pat. No. 5,980,057, the contents of which are incorporated herein by reference.

By employing insulating paint at locations 30 and 34, the electronic circuitry and/or chips employed within housing 36 are insulated from the heat source 26, and these components can operate within their preferred desired range.

While the invention has been described with respect a particular embodiment, it will be appreciated that the described invention may have other embodiment. Many other variations and applications of the invention will be apparent. The above specification and the detailed description of the preferred embodiment are to be considered as representative only, as the scope of the invention is intended to be covered by the scope of the claims, as interpreted by the Courts, and their reasonable and legal equivalents, as also interpreted by the Courts and applicable statutes.

1. In combination, a housing for a lightbulb, said housing having a reflecting surface facing said bulb and spaced therefrom, and insulating paint comprising a ceramic filler material applied to said surface to insulate that portion of the housing behind said insulating paint from the heat generated by said lightbulb.

2. A combination as set forth in claim 1 wherein said lightbulb is a floodlight.

3. A combination as set forth in claim 1 wherein said lightbulb is a conventional incandescent bulb.

4. A combination set forth in claim 1, wherein said lightbulb is of a conventional threaded type adapted to be threaded into a threaded socket.

5. A combination as set forth in claim 1, wherein said housing is adapted to be mounted into the ceiling.

6. A combination as set forth in claim 1, wherein said ceramic filler comprises a ceramic spherical compound.

7. A combination as set forth in claim 6 wherein said lightbulb is a floodlight.

8. A combination as set forth in claim 6 wherein said lightbulb is a conventional incandescent bulb.

9. A combination set forth in claim 6, wherein said lightbulb is of a conventional threaded type adapted to be threaded into a threaded socket.

10. A combination as set forth in claim 6, wherein said housing is adapted to be mounted into the ceiling.

11. A combination set forth in claim 1, wherein said insulating paint comprises Insuladd.

12. In combination, a wireless receiver for receiving audio signals, said wireless receiver connected to a speaker, said speaker being mounted in a housing adapted to be connected to a conventional source of electricity normally used to power electric bulbs, said housing further comprising a socket which holds said electric bulb, said housing comprising a reflector surface for said bulb, and insulating paint comprising a ceramic filler material applied to said reflector surface between said speaker and said light source to insulate the heat emanating from said light force from said speaker and related electronics.

13. A combination set forth in claim 12, wherein said insulating paint is applied to the driver of said speaker.

14. A combination set forth in claim 12, wherein said ceramic filler material comprises a ceramic spherical compound.
